(19) United States
(12) Patent Application Publication
(10) Pub. No.: US 2026/0018075 A1
(43) Pub. Date: Jan. 15, 2026

(54) SERVER APPARATUS, LEARNING SUPPORT METHOD, AND LEARNING SUPPORT SYSTEM

(71) Applicant: CASIO COMPUTER CO., LTD., Shibuya-ku, Tokyo (JP)

(72) Inventor: Katsunori ISHII, Tokyo (JP)

(73) Assignee: CASIO COMPUTER CO., LTD., Shibuya-ku, Tokyo (JP)

(21) Appl. No.: 19/260,122

(22) Filed: Jul. 3, 2025

(30) Foreign Application Priority Data
Jul. 9, 2024 (JP) 2024-110215

(51) Int. Cl. G09B 5/12

(52) U.S. Cl. CPC G09B 5/12

(57) ABSTRACT

A server apparatus includes a processor that executes a process of transmitting, to a terminal device that has made a request in response to the request from each of a plurality of terminal devices, display control data for causing a display of the terminal device that has made the request to display a predetermined screen related to learning and a control program for causing the terminal device that has made the request to execute predetermined processing related to the learning, in which the control program includes a first program for the plurality of terminal devices to directly transmit and receive first data related to the learning without through the server apparatus, and a second program for each of the plurality of terminal devices to update a display content of the predetermined screen related to the learning based on the first data.

### CROSS-REFERENCE TO RELATED APPLICATION

This application is based upon and claims the benefit of priority from Japanese Patent Application No. 2024-110215, filed Jul. 9, 2024, the entire contents of which are incorporated herein by reference.

### FIELD

The present disclosure relates to a server apparatus, a learning support method, and a learning support system.

### BACKGROUND

There are known conventional learning support systems that include a student terminal, a teacher terminal, and a server, which are connected via a communication network, and are configured such that a digital teaching material saved in the server can be accessed from the student terminal for learning, in which histories of learning the digital teaching material by a plurality of student terminals are collectively managed by the server, and the learning histories can be checked from the teacher terminal (for example, see Jpn. Pat. Appln. KOKAI Publication No. 2023-055305).

### SUMMARY

A server apparatus according to an embodiment is a server apparatus for learning support that manages learning using a plurality of terminal devices operated by a student or a teacher, the server apparatus including a processor that, in response to a request from each of the plurality of terminal devices, executes a process of transmitting, to the terminal device that has made the request, display control data for causing a display of the terminal device that has made the request to display a predetermined screen related to learning and a control program for causing the terminal device that has made the request to execute predetermined processing related to the learning, wherein the control program includes a first program for causing the plurality of terminal devices to directly transmit and receive first data related to the learning without passing through the server apparatus, and a second program for causing each of the plurality of terminal devices to update a display content on the predetermined screen related to the learning based on the first data.

### BRIEF DESCRIPTION OF DRAWINGS

FIG. 1 is a diagram illustrating an overall configuration of a learning support system 1 according to an embodiment of a server apparatus, a learning support method, and a program of the present disclosure.

FIG. 2 is a diagram for describing data on a display screen acquired by a web browser in a teacher or student terminal 20T (20S) of the learning support system 1 from a web server (learning support server) 10 via a communication network N and data on the display screen acquired by peer-to-peer (P2P) data transfer through WebRTC (Real-Time Communication) from another student or teacher terminal 20S (20T).

FIG. 3 is a block diagram illustrating a configuration of the web server (learning support server) 10 of the learning support system 1.

FIG. 4 is a block diagram illustrating a configuration of the user terminal 20 (teacher terminal 20T/student terminal 20S) of the learning support system 1.

FIG. 5 is a sequence diagram for describing operations in a case where classes are conducted by the teacher terminal 20T and the student terminal 20S grouped in the learning support system 1.

FIG. 6 is a flowchart illustrating processing by the web server (learning support server) 10, the teacher terminal 20T, and the student terminal 20S in a case where classes are conducted by the teacher terminal 20T and the student terminal 20S grouped in the learning support system 1.

FIG. 7 is a diagram illustrating a plurality of electronic tags TGt1 to TGt3 to which tasks are input on a mathematics/task notebook screen NBt displayed on the teacher terminal 20T.

FIG. 8 is a diagram illustrating an electronic tag TGs of a distributed task on a mathematics/task notebook screen NBs displayed on the student terminal 20S.

FIG. 9 is a diagram illustrating a list of electronic tags TGs1 to TGs4 according to task progress on student terminals 20S1 to 20S4 on a mathematics/task management screen Gt displayed on the teacher terminal 20T.

FIG. 10 is a diagram illustrating a list of the electronic tags TGs1 to TGs4 after submission of problem solutions in the task on the student terminals 201 to 20S4 on the mathematics/task management screen Gt displayed on the teacher terminal 20T.

### DETAILED DESCRIPTION

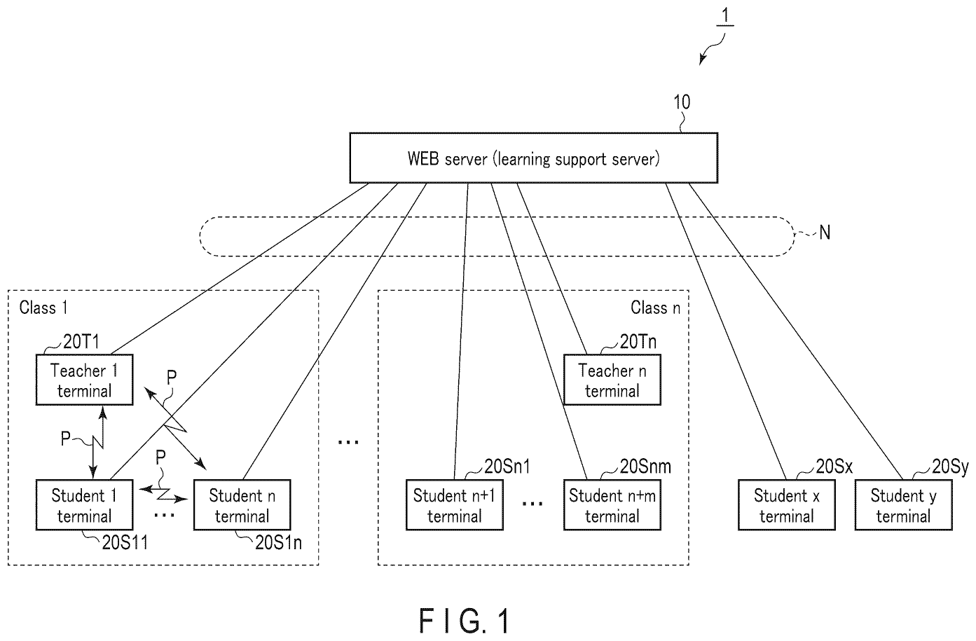

Hereinafter, a learning support system 1 according to embodiments of a server apparatus, a learning support method, and a program of the present disclosure will be described with reference to the drawings. As illustrated in FIG. 1, the learning support system 1 in an embodiment includes a learning support server 10 that is a web server (server apparatus), a teacher terminal 20T (terminal device) used by a school teacher (teacher), for example, having a communication function to communicate with the learning support server 10 via a communication network N, and a student terminal 20S (terminal device) used by a student. FIG. 1 illustrates an example in which a plurality of student terminals (20S11 to 20S1n . . . 20Sn1 to 20Snm) are grouped for each teacher terminal (20T1 . . . 20Tn) in class 1 . . . class n. The teacher terminal 20T and the student terminal 20S may be tablet terminals, personal computers (PCs), or other information processing devices (electronic devices) having functions similar to tablet terminals and PCs.

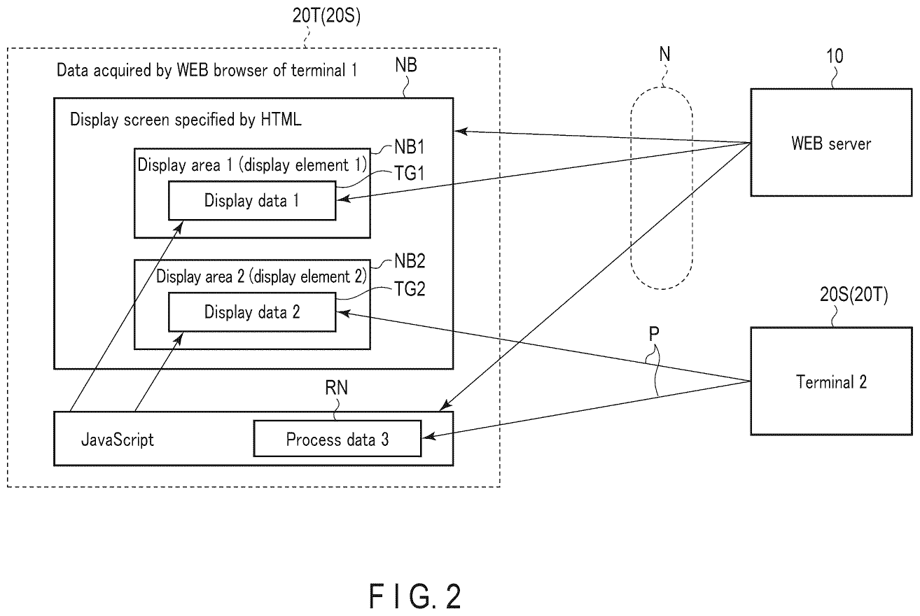

In the learning support system 1 of the embodiment, in the case of conducting classes in the normal state (in the case of setting the normal mode: the second mode), the teacher terminal 20T, the student terminals 20S1 to 20Sn that participate in classes 1 to n, and student terminals 20Sx and 20Sy that perform learning alone, access the web server (learning support server) 10 from their respective web browsers, and a display screen (NB, NB1) (predetermined screen) for learning is displayed according to Hyper Text Markup Language (HTML) data provided by the web server 10 as illustrated in FIG. 2, for example.

Then, various types of processing (RN) (predetermined processing) related to learning are executed according to a program such as JavaScript (registered trademark) specified by the HTML data, and a display element (display data TG1) is displayed in the display screen (NB1), for example.

In the case of conducting classes that satisfy a predetermined condition (in the case of setting the Real-Time Communication (WebRTC) use mode: the first mode), direct communication is performed between the web browsers of the terminals (between the teacher terminal 20T and the student terminal 20S/between the student terminal 20S1 and the student terminal 20Sn) without passing through the web server 10 by peer-to-peer (P2P) communication P through WebRTC, thereby to transmit and receive data used for screen display by HTML and data used for processing by JavaScript. For example, as illustrated in FIG. 2, part of a display element (display data TG2) in a display screen (NB2) acquired by the web browser is displayed by transmission and reception of the display data between terminals (between 20T and 205/20S and 20S) through the P2P communication P of WebRTC. Alternatively, data to be processed by JavaScript is transmitted through the P2P communication P of WebRTC, and a processing result (RN) using the data is displayed in the display element (display data TG2) specified by HTML data.

The predetermined condition for setting the first mode (WebRTC use mode) is to satisfy any one of (1) a target class needs to proceed in real time, (2) a large amount of data of teaching materials will be used in a target class, and (3) a large number of terminals are accessing the server for purposes other than the target class, for example, but the present invention is not limited to this. The first mode (WebRTC use mode) may be set for each class, may be manually set by the teacher terminal 20T as a condition of a class, or may be automatically set by the web server 10 through determination on the predetermined condition (1), (2), or (3). Since the first mode (WebRTC use mode) is set to perform direct communication between the terminals (between the teacher terminal 20T and the student terminal 20S/between the student terminal 20S1 and the student terminal 20Sn) without passing through the web server (learning support server) 10 and transmit and receive data used for screen display by HTML or data used for processing by JavaScript, the teachers and students can efficiently advance learning without being affected by a load of the web server (learning support server) 10.

The teacher terminals (20T1 . . . 20Tn) and the student terminals (20S11 to 20Sn1 20Sn1 to 20Snm) grouped for each class 1 . . . class n may be connected via an intra-school network via different routers. In this case, information (such as a private IP address) necessary for the student terminals 20Sx and 20Sy that perform learning alone to perform direct communication with the teacher terminal 20T and the student terminal 20S of the intra-school network through the P2P communication P of WebRTC without passing through the web server (learning support server) 10 may be acquired using a signaling server (not illustrated). The web server (learning support server) 10 may also serve as the signaling server.

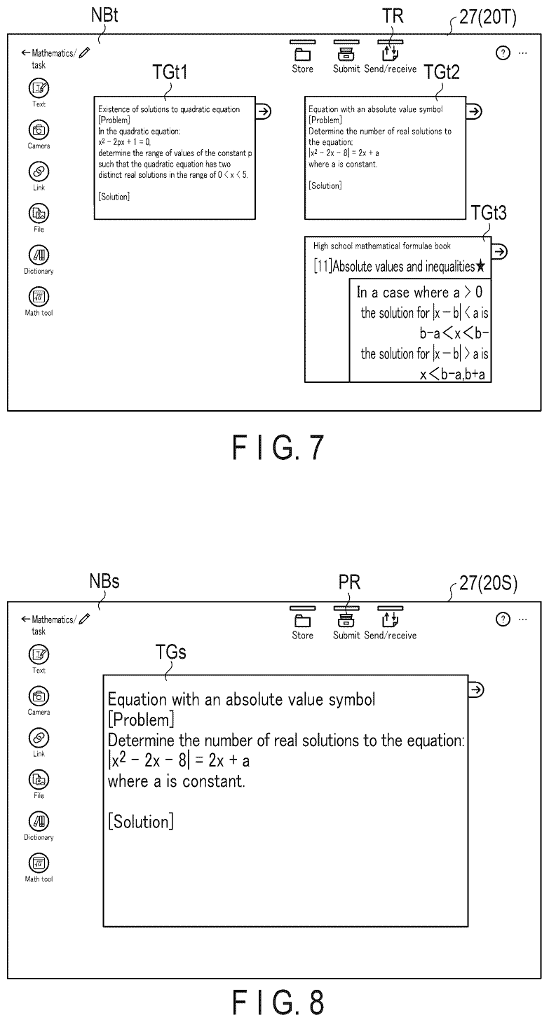

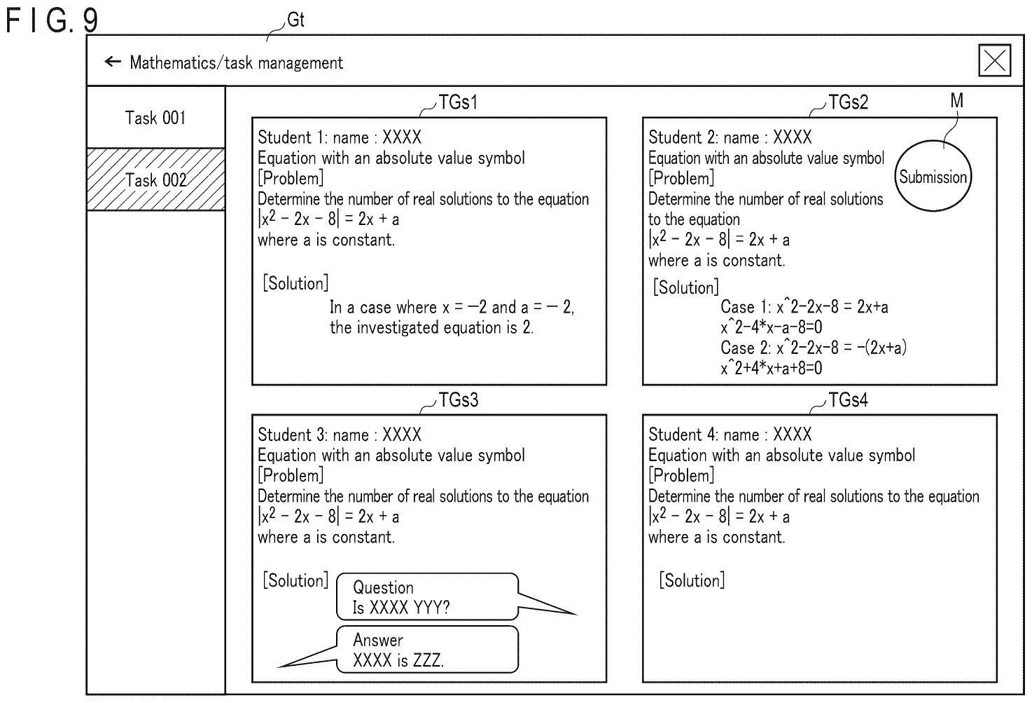

The teacher terminal 20T and the student terminal 20S that have registered for use of the web server (learning support server) 10 in the embodiment are allowed to perform at least processing described below by the learning support function of the web server (learning support server) 10. The registered terminals can generate, store, and display a notebook screen NB (predetermined screen) (see FIGS. 7 and 8) with an arbitrary name, and can generate, edit, store, and display an electronic tag TG in which arbitrary information is input using various tools (text/camera/link/file/dictionary/mathematical tool) in the generated notebook screen NB (predetermined processing). The electronic tag TG is a digital teaching material of a minimum unit for learning, and can be edited (updated) by enlarging an individual electronic tag TG and inputting characters, attaching a link destination URL, inputting a mathematical expression, or fetching a file (predetermined processing). The transmission, reception, and submission of tasks and materials performed between the teacher terminal 20T and the student terminal 20S are performed in units of electronic tags TG. The electronic tag TG can be arranged at and moved to an arbitrary position in the notebook screen NB (predetermined processing). For example, refer to the web site “ClassPad. net” <https://classpad. net/note/guide/contents/> (searched on Jun. 13, 2024).

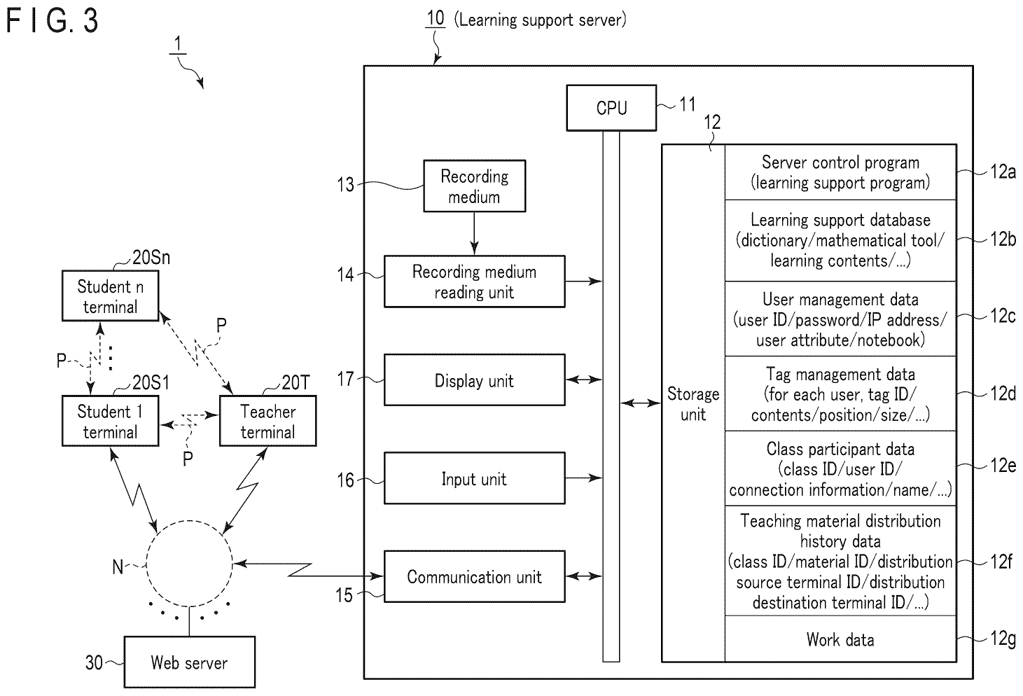

As illustrated in FIG. 3, the learning support server 10 includes a control unit (central processing unit (CPU)) 11 that is a computer, a storage unit (storage) 12, a recording medium reading unit 14, a communication unit (communicator) 15, an input unit 16, and a display unit 17. The control unit 11 is a processor that controls the operation of each unit of the circuit according to an input signal according to a user operation from the input unit 16 or a signal received by the communication unit 15 from the user terminal 20 (teacher terminal 20T/student terminal 20S) on the communication network N, according to a server control program (including learning support program) 12a stored in the storage unit 12. As the storage unit 12, in one example, a non-volatile memory such as a hard disk drive (HDD) or a solid state drive (SSD) capable of write and read processing at any given timing, a non-volatile memory such as a read only memory (ROM), and a volatile memory such as a random access memory (RAM) may be used in any combination. The communication unit 15 includes, in one example, one or more wireless or wired communication interface units to enable transmission and reception of information with the communication network N. As the wireless interface, for example, an interface which adopts a low-power wireless data communication standard such as a wireless local area network (LAN) is used.

The server control program 12a may be stored in advance in the storage unit 12, may be read and stored in the storage unit 12 from an external recording medium 13 such as a CD-ROM via the recording medium reading unit 14, or may be downloaded from a web server (In this case, the program server) 30 on the communication network N and read and stored in the storage unit 12. The server control program 12a includes a system program that controls the entire learning support server 10 and a learning support program. The learning support program includes learning support display control data described in HTML, and a learning support control program described in JavaScript specified in HTML, for example, for executing at least the above-described learning support function. The learning support control program includes a P2P communication program (first program) for directly performing the P2P communication P of WebRTC between the user terminals 20 (teacher terminal 20T/student terminal 20S) and transmitting and receiving data (first data) of the electronic tag TG generated in the notebook screen NB, for example, and a display update program (second program) for updating the content and position of the electronic tag TG (first data) in the notebook screen NB displayed on the user terminal 20 (teacher terminal 20T/student terminal 20S), for example.

In the storage unit 12, in addition to the storage area of a server control program 12a, a learning support database storage area 12b, a user management data storage area 12c, a tag management data storage area 12d, a class participant data storage area 12e, a teaching material distribution history data storage area 12f, and a work data storage area 12 g are secured. In the learning support database storage area 12b, learning support data serving as teaching materials including various dictionaries such as an English-Japanese dictionary and a Japanese dictionary, various mathematical tools such as functions, calculations, and equations/inequalities, and various learning contents such as reference books and problem collections are stored together with the control program. In the user management data storage area 12c, for each user of the user terminal 20 (teacher terminal 20T/student terminal 20S) in which a learning support server use application is installed, data of the contents of the notebook screen NB including the password registered by the user, the IP address (connection information), the user attribute (school, grade, class, name, class name to be participated (class ID), and the like), and the electronic tag TG generated according to the user operation are stored in association with the user ID (user identification information: application ID in this case). The notebook screen NB is stored in association with a notebook ID, and the electronic tag TG is stored in association with an electronic tag ID.

In the tag management data storage area 12d, for each user ID stored (registered) in the user management data storage area 12c, the electronic tag ID of the electronic tag TG included in the notebook screen NB, the data of the content included in the electronic tag TG and its attribute (data setting information such as generation/editing date and time and data format, sub-attributes, and the like), the coordinates indicating the display position (arrangement position) of the electronic tag TG on the notebook screen NB, the size of the electronic tag TG, and the like are stored in association with the notebook ID of the notebook screen NB generated according to the user operation. In the class participant data storage area 12e, for example, the user IDs of the participants in the class (the user IDs of the teacher and the student), the connection information (IP addresses) of the terminals of the participants (the teacher terminal 20T/the student terminal 20S), the names of the participants, and the like are listed and stored in association with the class name (class ID) of the class registered by the teacher terminal 20T, for example.

In the teaching material distribution history data storage area 12f, a teaching material ID of a teaching material (the electronic tag TG or the like in which a task or a material is incorporated) transmitted (distributed) to the student terminal 20S in a class, a terminal ID (for example, a user ID) of a terminal (the teacher terminal 20T/the student terminal 20S) which is a transmission (distribution) source, a terminal ID (for example, a user ID) of a terminal (the teacher terminal 20T/the student terminal 20S) which is a transmission (distribution) destination, and the like are stored in association with the class name (class ID) of the class. In the work data storage area 12g, various types of data generated or acquired in accordance with the control of the operation of each unit by the control unit 11 are temporarily stored as necessary.

In the learning support server 10 configured as described above, the control unit 11 controls the operation of each unit of the circuit according to a command described in the server control program 12a, and the software and the hardware operate in cooperation with each other to implement various functions as in the operations described later.

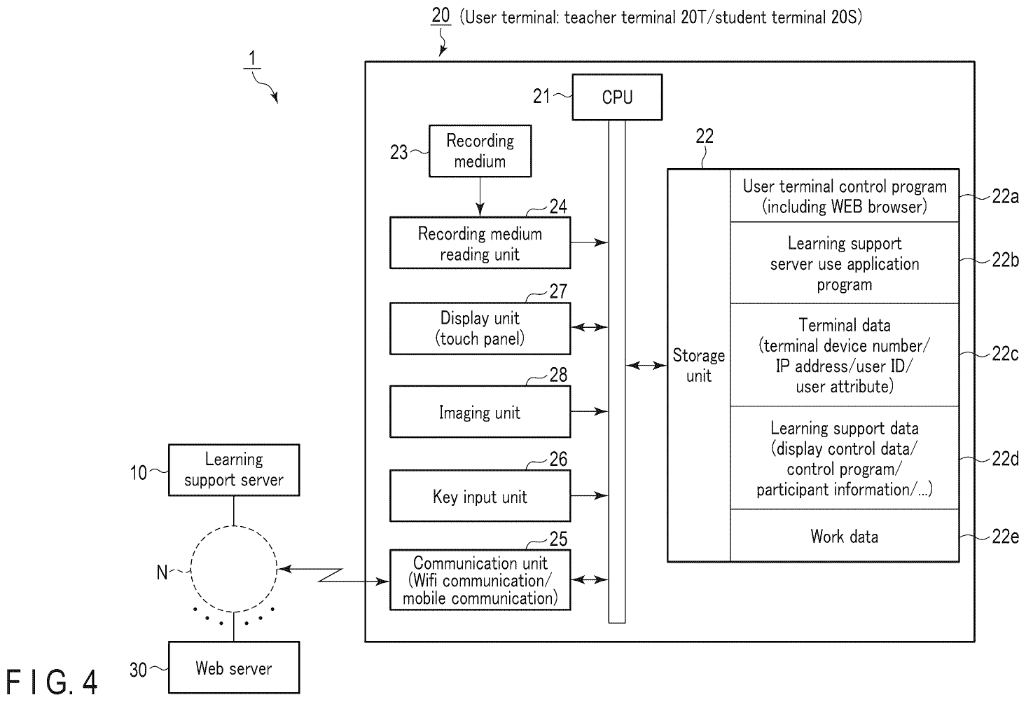

As illustrated in FIG. 4, the user terminal 20 (teacher terminal 20T/student terminal 20S) includes a control unit (CPU) 21 which is a computer, a storage unit (storage) 22, a recording medium reading unit 24, a communication unit (communicator, Wi-Fi (registered trademark) communication/mobile communication) 25, a key input unit 26, a touch panel display unit 27, and an imaging unit (camera) 28. The control unit 21 is a processor that controls the operation of each unit of the circuit according to the user terminal control program (including web browser) 22a and a learning support server use application program (learning support server use application) 22b stored in the storage unit 22. As the storage unit 22, in one example, a non-volatile memory such as a hard disk drive (HDD) or a solid state drive (SSD) capable of write and read processing at any given timing, a non-volatile memory such as a read only memory (ROM), and a volatile memory such as a random access memory (RAM) may be used in any combination. The communication unit 25 includes, in one example, one or more wireless or wired communication interface units to enable transmission and reception of information with the communication network N. As the wireless interface, for example, an interface which adopts a low-power wireless data communication standard such as a wireless local area network (LAN) is used. The user terminal control program 22a may be stored in advance in the storage unit 22, may be read by the recording medium reading unit 24 from an external recording medium 23 such as a memory card and stored in the storage unit 22, or may be downloaded from a web server (here, the program server) 30 on the communication network N via the communication unit 25 and stored in the storage unit 22. The learning support server use application 22b is downloaded from the web server (here, the program server of an application store) 30 on the communication network N via the communication unit 25 and stored in the storage unit 22.

The user terminal control program 22a includes not only a system program for controlling the entire user terminal 20 (teacher terminal 20T/student terminal 20S) but also a program (a web browser or the like) for transmitting and receiving various data by establishing communication connection with an external communication device including the learning support server 10 and the web server 30 on the communication network N as needed in cooperation with various application programs stored in the storage unit 22. The learning support server use application 22b includes a program for performing communication connection with the learning support server 10 and executing input/output processing of data according to at least the above-described learning support function.

In the storage unit 22, in addition to a program storage area for storing the user terminal control program 22a and the learning support server use application 22b, a terminal data storage area 22c, a learning support data storage area 22d, a work data storage area 22e, and the like are secured. In the terminal data storage area 22c, in addition to a terminal device number for communicably connecting to an external communication device including the learning support server 10 and the web server 30 on the communication network N by a web browser, data such as an IP address, a user ID (user identification information: here, application ID), and a user attribute (school, grade, class, name, class name to be participated (class ID), and the like) for directly communicably connecting to another user terminal 20 (student terminal 20S/teacher terminal 20T) through P2P communication by WebRTC is stored as terminal data unique to the user terminal 20. If the first mode (WebRTC use mode) is set in response to establishment of communication connection with the learning support server 10 according to the learning support server use application 22b and transmission of a participation request in the target class, in the learning support data storage area 22d, the learning support display control data and the learning support control program received from the learning support server 10, participant information (including connection information, name, and the like) of the user terminal (the student terminal 20S/the teacher terminal 20T) having made the participation request for the same class, and the like, are stored. In the work data storage area 22e, various types of data generated or acquired in accordance with the control of the operation of each unit by the control unit 21 are temporarily stored as necessary.

In the user terminal 20 (the student terminal 20S/the teacher terminal 20T) configured as described above, the control unit 21 controls the operation of each unit of the circuit according to a command described in the user terminal control program 22a and the learning support server use application 22b, and the software and the hardware operate in cooperation with each other to implement various functions as in the operations described later.

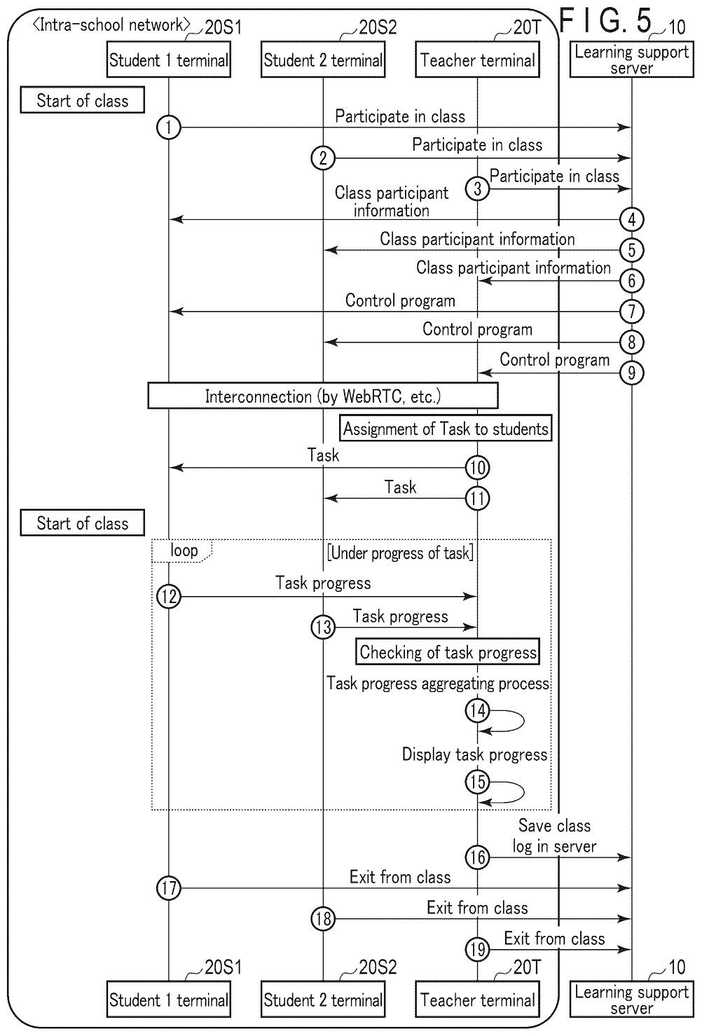

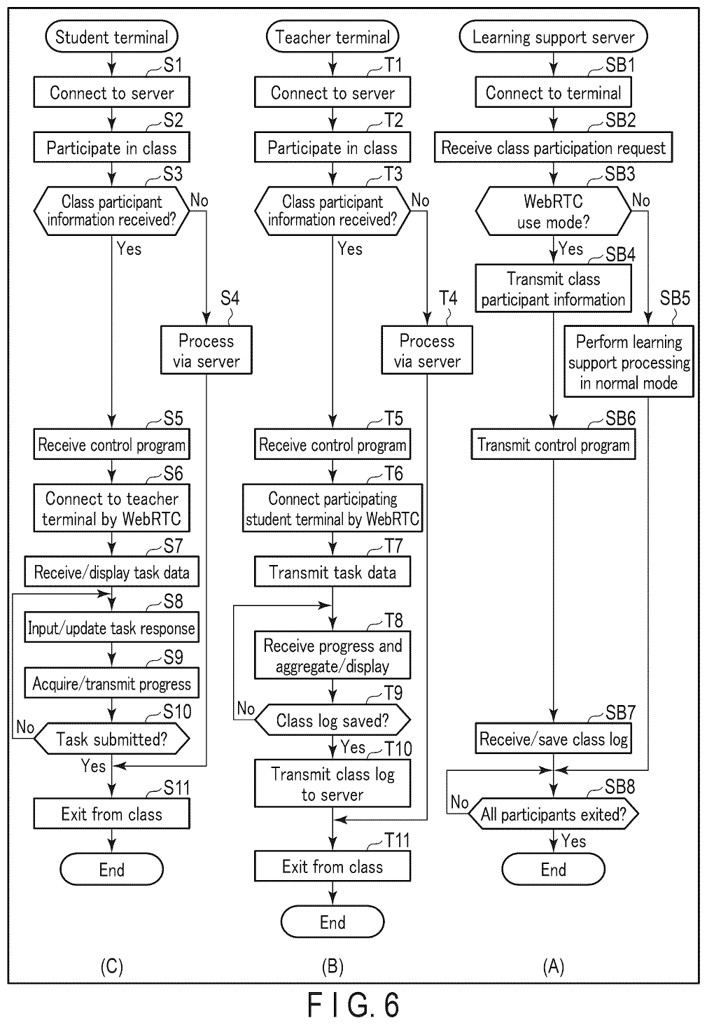

Next, operations of the learning support system 1 according to the embodiment will be described. It is assumed here that a certain target class is performed using the learning support server 10 by the teacher terminal 20T and the student terminals 20S (20S1, 20S2, . . . ) belonging to a specific group registered in the user management data storage area 12c and the class participant data storage area 12e of the learning support server 10. In the sequence diagram of FIG. 5, the circled numbers representing the sequence of operation are use-prohibited characters in the specification. Therefore, the circled numbers of FIG. 5 are indicated by the same numbers enclosed in parentheses ( ) in the specification. As illustrated in FIGS. 6 (B) and 6 (C), in a case where the teacher terminal 20T and the student terminal 20S each transmit a request for connection (login) to the learning support server 10 according to the learning support server use application 22b (step T1/S1), as illustrated in FIG. 6 (A), the learning support server 10 confirms the registration of the teacher terminal 20T and the student terminal 20S based on the user management data (12c) and the class participant data (12e), and communicably connects to the teacher terminal 20T and the student terminal 20S (step SB1). In a case where the teacher terminal 20T and the student terminal 20S transmit a participation request for a class to the learning support server 10 according to their respective user operations of the teacher terminal 20T and the student terminal 20S (20S1, 20S2, . . . ) (steps T2/S2: (1), (2), and (3) in FIG. 5), the learning support server 10 receives the participation requests for the class transmitted from the teacher terminal 20T and the student terminal 20S (step SB2), and determines whether the first mode (WebRTC use mode) satisfying a predetermined condition applies or not (second mode (normal mode)) (step SB3).

If the learning support server 10 determines that the first mode (WebRTC use mode) applies satisfying the predetermined condition (for example, (1) the target class needs to proceed in real time, (2) a large amount of data of teaching materials will be used in the target class, or (3) a large number of terminals are accessing the server for purposes other than the target class) (step SB3 (Yes)), the learning support server 10 reads information (IP address, name, and the like) required for at least connection of each of the teacher terminal 20T and the student terminal 20S (user ID) associated with the class ID of the participation-requested class from the class participant data storage area 12e, and transmits the read information to the teacher terminal 20T and the student terminal 20S as the class participant information (step SB4: (4), (5), and (6) in FIG. 5). The learning support server 10 also transmits the learning support display control data and the learning support control program included in the learning support program (12a) to the teacher terminal 20T and the student terminal 20S (step SB6: (7), (8), and (9) in FIG. 5). Upon receipt of the class participant information transmitted from the learning support server 10, the teacher terminal 20T and the student terminal 20S store the received class participant information in the learning support data storage area 22d (step T3/S3). Subsequently, upon receipt of the learning support display control data and the learning support control program transmitted from the learning support server 10, the terminals also store the received learning support display control data and learning support control program in the learning support data storage area 22d (step T5/S5).

The teacher terminal 20T and the student terminal 20S (20S1, 20S2, . . . ) are communicably connected to each other through the P2P communication P of WebRTC according to the learning support control program and the class participant information (IP address or the like) stored in the learning support data storage area 22d, so that the terminals (20T/20S1/20S2/ . . . ) grouped as the class participants are directly connected to each other (step T6/S6). The teacher terminal 20T displays a mathematics/task notebook screen NBt on the touch panel display unit 27, and generates and displays electronic tags TGt1, TGt2, and TGt3 to which tasks have been input on the notebook screen NBt as illustrated in FIG. 7, for example, in accordance with the learning support display control data and the learning support control program stored in the learning support data storage area 22d. Then, the electronic tag TGt2 to which a task (“equation including an absolute symbol”) to be a question asked to the participants of the class has been input is designated, and the student terminals 20S1, 20S2, . . . of the participants are designated in order based on the class participant information (name and the like) stored in the learning support data storage area 22d, and a [transmission/reception] icon TR is operated (pressed). Accordingly, the data of the electronic tag TGt2 of the designated task “equation including an absolute symbol” is directly transmitted from the teacher terminal 20 to each of the student terminals 20S1, 20S2, . . . of the participants (first control) (step T7: (10) and (11) in FIG. 5).

The data (data to be distributed) of the electronic tag TGt2 of the task may not be transmitted individually (in parallel) from the teacher terminal 20 to the student terminals 20S1, 20S2, . . . , but may be transmitted in series, for example, in the order of the student terminals 20Sn designated by the teacher terminal 20T, such as transmission from the teacher terminal 20T to the first student terminal 20S1 and transmission from the first student terminal 20S1 to the second student terminal 20S2 (this corresponds to the connection form of ring-type or star-type P2P communication, for example). This makes it possible to distribute the data more efficiently while distributing the load on a specific terminal (here, the teacher terminal 20T) among the plurality of grouped terminals (here, the teacher terminal 20 and the student terminals 20S1, 20S2, . . . ). The data of the electronic tag TGt can be transmitted (distributed) from the teacher terminal 20T to the student terminals 20S1, 20S2, . . . as a material in which text, an image, a moving image, or the like having a larger data amount is captured. In this case, it is more important to distribute the load by directly transmitting and receiving the data of the electronic tag (material) TG between the terminals of the class participants without passing through the learning support server 10.

Upon receipt of the data of the electronic tag TGt2 of the task “equation including an absolute symbol” transmitted from the teacher terminal 20T, the student terminals 20S1, 20S2, . . . display a mathematics/task notebook screen NBs on the touch panel display unit 27, and display the received electronic tag TGs of the task “equation including an absolute symbol” on the notebook screen NBs, as illustrated in FIG. 8, for example, in accordance with the learning support display control data and the learning support control program stored in the learning support data storage area 22d (step S7). In response to the user (student) operation, the student terminals 20S1, 20S2, . . . display the input question or answer to respond to the task of the electronic tag TGs being displayed, and edit and update the content of the electronic tag TGs (step S8). The student terminals 20S1, 20S2, . . . acquire the updated data of the electronic tag TGs as the progress, at arbitrarily set regular time intervals, for example, according to the function for the student terminal 20S of acquiring the progress of the task included in the learning support control program, and transmit the data to the teacher terminal 20T (first control) (step S9: (12) and (13) in FIG. 5).

Upon receipt of the data of the electronic tag TGs (TGs1, TGs2, . . . ) indicating the progress of the task transmitted from the student terminals 20S (20S1, 20S2, . . . ), the teacher terminal 20T aggregates the electronic tags TGs1, TGs2, . . . received from the student terminals 20S1, 20S2,. and displays a mathematics/task management screen Gt on which a list of the electronic tags TGs is arranged with the names of the students added thereto, as illustrated in FIG. 9, for example, according to the function for the teacher terminal 20T of aggregating the progress of the task included in the learning support control program (step T8: (14) and (15) in FIG. 5). Every time the teacher terminal 20T receives the data of the electronic tags TGs1, TGs2, . . . as the progress of the task transmitted from the student terminals 20S1, 20S2, . . . at the regular time intervals, the teacher terminal 20T repeatedly updates the corresponding electronic tag TGsn on the task management screen Gt by overwriting, for example (steps S8 and S9/T8: [loop] in FIG. 5). Data transmission and reception performed between the terminals (20T/20S1/20S2/ . . . ) grouped as the participants of the class in a state where the terminals are directly connected through the P2P communication P of WebRTC (for example, equivalent to the connection form of mesh-type P2P communication) is performed such that the terminal on the transmission side checks the time slot allocated in advance to each terminal. Available connection forms of P2P communication by a plurality of terminals include various forms such as the ring type, the star type, and the mesh type. Transmission may be controlled according to the connection form. For example, in the case of using the ring type, a plurality of terminals may relay data in a predetermined order from a transmission source terminal to a transmission destination terminal, and in the case of using the mesh type, each terminal may check the time slot allocated in advance to each terminal such that transmission of the same data does not overlap.

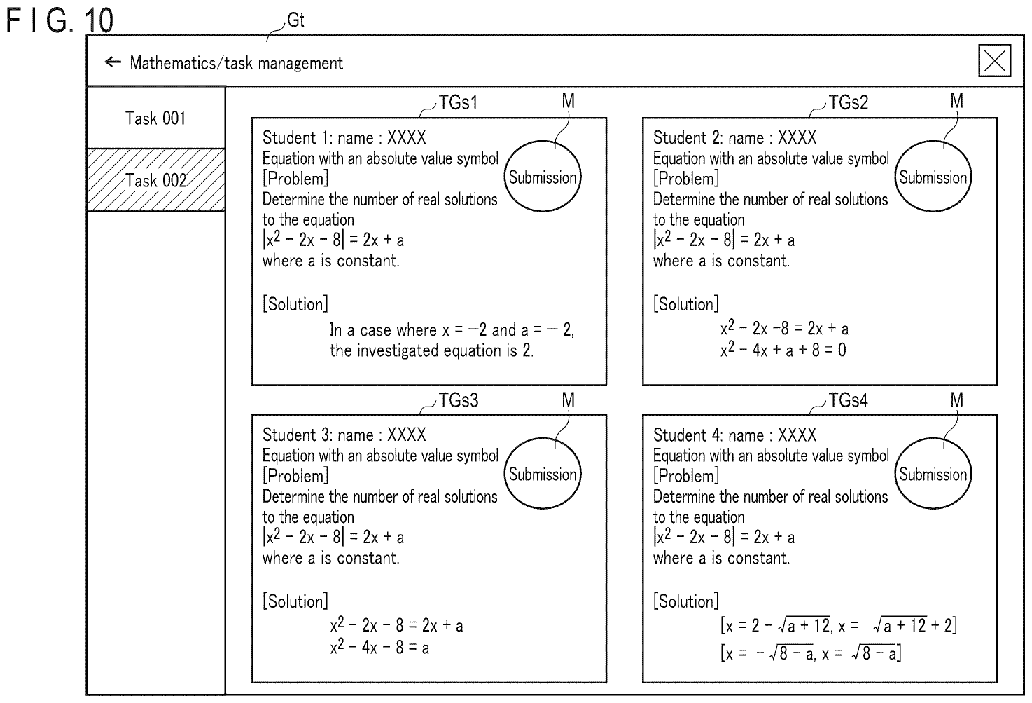

In the student terminal 20S, in a case where the input of a solution to the electronic tag TGs of the task is completed and a [submission] icon PR (see FIG. 8) on the notebook screen NBs is operated (pressed), the data of the electronic tag TGs including the information of submission is transmitted to the teacher terminal 20T. In the teacher terminal 20T, the electronic tag TGs2 to which a “submission” mark M is added is displayed so as to overwrite the corresponding electronic tag TGs2 on the task management screen Gt as illustrated in FIG. 9, for example. Thereafter, upon receipt of the data of the electronic tags TGs1, TGs3, . . . including the information of submission from the other student terminals 20S1, 20S3, . . . participating in the class, the teacher terminal 20T displays the electronic tags TGs1, TGs2, to which the “submission” mark M is added so as to overwrite the electronic tags TGs1, TGs3, . . . on the task management screen Gt as illustrated in FIG. 10, for example.

In the processing executed by the teacher terminal 20T and the student terminal 20S directly communicably connected through the P2P communication P according to the learning support display control data and the learning support control program received by the teacher terminal 20T and the student terminal 20S from the learning support server 10 in the first mode (WebRTC use mode) (steps T5 to T9/S5 to S10), the notebook screens NBt and NBs and the task management screen Gt illustrated in FIGS. 7 to 10 correspond to the display area 2 (NB2) illustrated in FIG. 2, the electronic tags TGt and TGs illustrated in FIGS. 7 to 10 correspond to the display data 2 (TG2) illustrated in FIG. 2, and data for issuing an instruction on change or new generation of the contents, positions, and sizes of the electronic tags TGt and TGs correspond to the processing data 3 (RN) illustrated in FIG. 2, for example. In the case of updating the contents of the electronic tags TGt and TGs already displayed on the teacher terminal 20T and the student terminal 20S, the learning support control program may perform processing on the assumption that the electronic tags TGt and TGs correspond to the display area 2 (NB2) illustrated in FIG. 2 and the update information in the electronic tags TGt and TGs corresponds to the display data 2 (TG2) illustrated in FIG. 2.

In this manner, in the first mode (WebRTC use mode) that satisfies the predetermined condition, the grouped teacher terminal 20T and student terminal 20S (20S1, 20S2, . . . ) perform a class using the learning support server 10 such that the teacher terminal 20T transmits the electronic tag TGt in which the task or the material created by the teacher terminal 20T is incorporated to the student terminals 20S1, 20S2, . . . , the student terminals 20S1, 20S2, . . . transmit the electronic tags TGs1, TGs2, . . . of the task updated by inputting the solution to the teacher terminal 20T at any time, and the teacher terminal 20T aggregates the electronic tags, directly through the P2P communication P of WebRTC without passing through the learning support server 10. Accordingly, for example, even if a large amount of data of teaching materials such as tasks and references is to be transmitted and received between the teacher terminal 20T and the student terminal 20Sn or a large number of terminals are accessing the learning support server 10, it is possible to perform an efficient class with high real-time property using the learning support function of the learning support server 10, while not being affected by the load of the learning support server 10. In addition, during the execution of the learning support function without passing through the learning support server 10 in the first mode (WebRTC use mode), even if the communication network N to the learning support server 10 is interrupted by a failure, it is possible to proceed with a class, which achieves improvement in the fault resistance.

The aggregation of the electronic tags TGs1, TGs2, . . . , that indicate the progress of the task from the student terminals 20S1, 20S2, . . . performed by the teacher terminal 20T may include analysis of the degree of progress of finding a solution to the problem in the task, the input speed, the distribution of the contents, and the like. In this case, the analysis of finding a solution may be performed in a distributed manner by the student terminals 20S1, 20S2,., and the data of the analysis results may be transmitted to the teacher terminal 20T together with the data of the electronic tags TGs1, TGs2, . . . to which the solutions from the student terminals 20S1, 20S2,. are input, and the data may be aggregated by the teacher terminal 20T.

For example, as illustrated in FIG. 10, in a state where the electronic tags TGs1, TGs2, . . . to which the solutions to the problem submitted from the student terminals 20S1, 20S2, . . . participating in the class have been already input are aggregated and displayed in a list, the teacher terminal 20T issues an instruction for saving a class log in order to record the series of operations in this class in response to the user (teacher) operation (step T9 (Yes)). Then, the teacher terminal 20T transmits to the learning support server 10, for example, the data of the electronic tags TGt1, TGt2, and TGt3 of the task created and displayed on the mathematics/task notebook screen NBt illustrated in FIG. 7 and the data of the submitted electronic tags TGs1, TGs2, . . . of the task from the student terminals 20S1, 20S2, aggregated and displayed on the task management screen Gt illustrated in FIG. 10 as the class log (step T10: (16) in FIG. 5). The class log may include distribution history data (teaching material ID, distribution source terminal ID, and distribution destination terminal ID) which is transmission information of the task or reference (teaching materials) distributed (transmitted) to the student terminal 20Sn and data of analysis results of solutions to the problem. The distribution history data of the task and the reference (teaching materials) for the student terminal 20Sn may be transmitted not only from the teacher terminal 20T as the distribution source to the learning support server 10, but also from the student terminal 20Sn as the distribution destination to the learning support server 10.

Upon receipt of the class log transmitted from the teacher terminal 20T, the learning support server 10 updates and saves the notebook screens NBt/NBs of the relevant teacher terminal 20T and student terminals 20S1, 20S2, . . . stored in the user management data storage area 12c, and updates and saves the data of the electronic tags TGtn/TGsn of the relevant teacher terminal 20T and student terminals 20S1, 20S2, . . . stored in the tag management data storage area 12d, according to the data of the electronic tags TGt1, TGt2, and TGt3 of the task on the mathematics/task notebook screen NBt and the data of the electronic tags TGs1, TGt2, . . . of the task submitted by the students on the task management screen Gt, which are included in the class log, for example (step SB7). The distribution history data of the task and the reference (teaching materials) distributed to the student terminal 20S is updated and stored in the teaching material distribution history data storage area 12f, and the data of the analysis results of the solutions of the problem is stored in association with the management data corresponding to the teacher terminal 20T in the user management data storage area 12c or stored as the data of the electronic tag TGt corresponding to the teacher terminal 20T in the tag management data storage area 12d, so that the data can be viewed from the teacher terminal 20T. The class log (including the distribution history of the teaching materials) aggregated and analyzed by the teacher terminal 20T may be transmitted to and saved in the learning support server 10, and may also be saved as a backup in the learning support data storage area 22d of the teacher terminal 20T itself, thereby improving the fault resistance in a situation where the connection with the learning support server 10 is difficult.

In a case where the electronic tags TGs1, TGs2, . . . updated by inputting the solution of the problem have been submitted (step S10 (Yes)), the student terminals 20S1, 20S2, transmit a request for exit (logout) from the class to the learning support server 10 (step S11: (17) and (18) in FIG. 5). After transmitting the class log to the learning support server 10, the teacher terminal 20T also transmits a request for exit (logout) from the class to the learning support server 10 (step T11: (19) in FIG. 5). Upon receipt of the request for exit (logout) from the teacher terminal 20T and the student terminals 20S1, 20S2, . . . corresponding to the participant information of the current class, the learning support server 10 ends a series of learning support processes (step SB8 (Yes)).

On the other hand, upon receipt of the class participation requests transmitted from the teacher terminal 20T and the student terminal 20S (step SB2), if the learning support server 10 determines that the mode is not the first mode (WebRTC use mode) satisfying the predetermined condition but the second mode (normal mode) (step SB3 (No)), the learning support server 10 does not perform transmission of the class participant information (step SB4) to the teacher terminal 20T and the student terminals 20S1, 20S2, Based on the class participant information stored (registered) in the class participant data storage area 12e, the learning support server 10 executes all the learning support processes including generation, storage, and display of the notebook screens NB, generation, storage, and display of the electronic tag TG, transmission (distribution) of data of the electronic tags TG (teaching materials) in which tasks and references are incorporated, update and saving of the class log (including a distribution history of the tasks and references), and the like in the normal mode via the learning support server 10 according to the user (teacher/student) operations of the teacher terminal 20T and the student terminals 20S1, 20S2, . . . (second control) (steps SB5/T4/S4).

In conventional learning support systems, since the server collectively manages the distribution of digital teaching materials to a plurality of student terminals and the learning histories, the digital teaching materials and the learning histories can be used from various student terminals and teacher terminals as long as the server can be accessed. However, in a case where a large number of terminals are accessing the server, or in a case where a large amount of data of the digital teaching materials is used in a class, the use efficiency of the system may become deteriorated due to an access failure, a delay in data transmission, or the like.

An object of the present invention is to provide a server apparatus, a learning support method, and a learning support system capable of improving use efficiency of the learning support system in which a server manages the use of the system by student terminals and teacher terminals.

According to the learning support system 1 of the embodiment, for example, in order for the teacher terminal 20T and the plurality of student terminals 20Sn in a specific group according to a class to perform learning using the learning support server 10 by the web browser, if the predetermined condition is satisfied such as (1) the target class needs to proceed in real time, (2) a large amount of data of teaching materials will be used in the target class, or (3) a large number of terminals are accessing the server for purposes other than the target class, the learning support server 10 sets the first mode (P2P communication mode by WebRTC), transmits class participant information including IP addresses (connection information) of the terminals 20T/20Sn to the terminals 20T/20Sn, and transmits to the terminals 20T/20Sn the learning support display control data and the learning support control program for executing the learning support function of the learning support server 10 without passing through the learning support server 10. Then, the teacher terminal 20T and the student terminal 20Sn generate and display an arbitrary notebook screen NB (predetermined screen) or electronic tag TG according to the learning support display control data and the learning support control program, and for example, in a case where there is an electronic tag TGt in which a task or a reference that needs to be transmitted (distributed) from the teacher terminal 20T to the student terminal 20Sn is incorporated, the terminals 20T/20Sn are mutually connected by one-to-one communication by the WebRTC, and the electronic tag TGt to be distributed is directly transmitted and received without passing through the learning support server 10 (first control). The student terminal 20Sn edits (updates) the distributed electronic tag TGt by inputting a solution to the problem in the task (predetermined processing), and directly transmits the edited electronic tag TGs as data corresponding to the progress of the task to the teacher terminal 20T without passing through the learning support server 10, and the teacher terminal 20T displays a list of the electronic tags TGsn indicating the progress of the student terminals 20Sn on the task management screen Gt. The teacher terminal 20T transmits and saves records of created data, updated data, and transmitted (distributed) data according to learning in the first mode to the learning support server 10 as a class log to update various data managed corresponding to the terminal 20T/20Sn (class participants) in the learning support server 10 to the latest state.

Therefore, even if a large amount of data of teaching materials (digital teaching materials) such as tasks and materials is to be transmitted and received between the teacher terminal 20T and the student terminal 20Sn, or even if a large number of terminals is accessing the learning support server 10, it is possible to perform an efficient class with high real-time property while securing the resistance to interruption of the communication network N without being affected by the load of the learning support server 10. As a matter of course, the digital teaching materials distributed to the student terminal 20Sn are not limited to the data of the electronic tag TG. This makes it possible to improve the use efficiency of the learning support system in which the server manages the use of the system by the student terminals and the teacher terminals.

The methods of the processing by the learning support system 1 in the above embodiment, that is, the methods of the processing of the learning support server 10, the processing of the teacher terminal 20T, and the processing of the student terminal 20S illustrated in the sequence diagram of FIG. 5 and the flowchart of FIG. 6 can be stored and distributed, as a program that can be executed by a computer, in a medium of an external recording device such as a memory card (ROM card, RAM card, or the like), a magnetic disk (floppy (registered trademark) disk, hard disk, or the like), an optical disk (CD-ROM, DVD, or the like), or a semiconductor memory. Then, the control unit (CPU) of the information processing apparatus (electronic apparatus) reads the program from the medium of the external recording device into a storage device, and the operations of the control unit are controlled by the read program, so that the various functions described in the embodiment can be implemented, and similar processing can be executed by the above-described methods.

In addition, data of the program for implementing the methods can be transmitted on a communication network (N) in the form of a program code, and the data of the program can be taken into an information processing apparatus (electronic apparatus) from a computer apparatus (program server) connected to the communication network (N) and stored in a storage device to implement the above-described various functions.

The disclosure herein is not limited to the foregoing embodiments. For practical implementation, various modifications may be adopted without departing from its gist. The various embodiments may be discretionarily combined for implementation, and such combinations will produce combined effects. Moreover, the embodiments involve various aspects, and appropriate combinations of the disclosed features will permit various teachings to be derived. For example, if omission of several features from the entire configuration or structure disclosed for the embodiments can realize the intended object and provide the effects, the configuration or structure after such omission may be derived as the disclosed teachings.

What is claimed is:

1. A server apparatus for learning support that manages learning using a plurality of terminal devices operated by a student or a teacher, the server apparatus comprising
a processor that, in response to a request from each of the terminal devices, executes a process of transmitting, to the terminal device that has made the request, display control data for causing a display of the terminal device that has made the request to display a predetermined screen related to learning and a control program for causing the terminal device that has made the request to execute predetermined processing related to the learning, wherein
the control program includes a first program configured to cause the terminal devices to directly transmit and receive first data related to the learning without passing through the server apparatus, and a second program configured to cause each of the terminal devices to update a display content on the predetermined screen related to the learning based on the first data.

2. The server apparatus according to claim 1, wherein
during execution of learning using the terminal devices by the teacher or the student belonging to a specific group, in response to a request from each of the terminal devices, the processor executes a process of transmitting display control data for updating the display content on the predetermined screen related to the learning to the terminal device that has made the request,
the first program causes the terminal devices to execute a process of directly transmitting and receiving the first data between the terminal devices without passing through the server apparatus during execution of the learning, and
the second program causes the terminal devices to execute a process of updating the display content on the predetermined screen related to the learning based on the first data during execution of the learning.

3. The server apparatus according to claim 1, wherein
the learning is learning by a class in which the teacher and a plurality of the students participate,
the processor executes a process of receiving data of a task in the class from a terminal device operated by the teacher and storing the data of the task in a storage, or a process of receiving data issuing an instruction for editing of the data of the task in the class from the terminal device operated by the teacher and editing the data of the task in the class stored in the storage,
the processor executes a process of transmitting, in response to a request from each of the terminal devices, display control data for updating the display content of a predetermined screen related to the learning based on the data of the task in the class stored in the storage to the terminal device that has made the request,
the first program causes the terminal device operated by each of the students to execute a process of directly transmitting the first data related to progress of the task from the terminal device operated by each student to the terminal device operated by the teacher without passing through the server apparatus, and
the second program causes the terminal device operated by the teacher to execute a process of updating a display content indicating the progress of the task of each student displayed on the predetermined screen related to the learning displayed on the display of the terminal device operated by the teacher, based on the first data acquired from the terminal device operated by the student.

4. The server apparatus according to claim 1, wherein
the server apparatus is a web server,
the display control data is described by HTML,
the first program and the second program are programs specified by the HTML, and
the first program is a program configured to transmit and receive the first data between the terminal devices by performing direct communication using WebRTC between the terminal devices without passing through the web server.

5. The server apparatus according to claim 1, wherein
the control program includes a program configured to, in a first mode, cause the terminal devices to execute a process of updating the display content on the predetermined screen related to the learning by a process including first control in which the terminal devices directly communicates with each other without passing through the server apparatus to acquire the first data, and in a second mode, cause the processor to execute a process of updating the display content on the predetermined screen related to the learning by second control in which the terminal devices acquires the first data from the server apparatus without performing the first control.

6. The server apparatus according to claim 5, wherein
the learning is learning by a class in which the teacher and a plurality of the students participate, and
the processor sets the first mode in a case of satisfying any one of a first condition that the class needs to proceed in real time, a second condition that a large data amount of teaching material is to be used, and a third condition that a large number of terminal devices, other than the terminal devices of the teacher and the students participating in the class, are accessing the server apparatus.

7. The server apparatus according to claim 1, wherein
the predetermined screen related to the learning is a screen on which a plurality of electronic tags is arranged,
the first data includes data indicating a change in arrangement positions of the electronic tags, data indicating a change in contents of the electronic tags, or data indicating generation of a new electronic tag, performed by operating any one of the terminal devices, and
the second program includes a program configured to cause each of the terminal devices to update the contents or the arrangement positions of the electronic tags arranged on the predetermined screen related to the learning based on the first data.

8. The server apparatus according to claim 7, wherein
the learning is learning by a class in which the teacher and a plurality of the students participate,
the first program includes a program configured to each of the terminal devices to acquire the first data during execution of the class, and
the second program includes a program configured to cause each of the terminal devices to update the predetermined screen related to the learning during execution of the class.

9. A learning support method comprising:
executing, by a processor of a server apparatus for learning support that manages learning using a plurality of terminal devices operated by a student or a teacher, in response to a request from each of the terminal devices, a process of transmitting, to the terminal device that has made the request, display control data for causing a display of the terminal device that has made the request to display a predetermined screen related to learning and a control program for causing the terminal device that has made the request to execute predetermined processing related to the learning, wherein
the control program includes a first program configured to cause the terminal devices to directly transmit and receive first data related to the learning without passing through the server apparatus, and a second program configured to cause each of the terminal devices to update a display content on the predetermined screen related to the learning based on the first data.

10. A learning support system comprising:
a plurality of terminal devices operated by a student or a teacher; and
a server apparatus for learning support that manages learning using the terminal devices, wherein
the server apparatus includes
a processor that, in response to a request from each of the terminal devices, executes a process of transmitting, to the terminal device that has made the request, display control data for causing a display of the terminal device that has made the request to display a predetermined screen related to learning and a control program for causing the terminal device that has made the request to execute predetermined processing related to the learning, and
the control program includes a first program configured to cause the terminal devices to directly transmit and receive first data related to the learning without passing through the server apparatus, and a second program configured to cause each of the terminal devices to update a display content on the predetermined screen related to the learning based on the first data.
